(19) United States
(12) Patent Application Publication
(10) Pub. No.: US 2022/0361454 A1
(43) Pub. Date: Nov. 17, 2022

(54) CARABINER LEASH HANDLE

(71) Applicant: HitchCo., LLC, Homewood, AL (US)

(72) Inventors: Foster D. PHILLIPS, Homewood, AL (US); Seth Griffin, Homewood, AL (US)

(21) Appl. No.: 17/744,389

(22) Filed: May 13, 2022

Related U.S. Application Data
(60) Provisional application No. 63/188,901, filed on May 14, 2021.

(51) Int. Cl. A01K 27/00; F16B 45/02

(52) U.S. Cl. CPC A01K 27/004; F16B 45/023; F16B 45/028

(57) ABSTRACT

The present disclosure generally relates to leash apparatuses, and more particularly to leashes having a carabiner handle. The carabiner leash of the present disclosure may offer a comfortable handle, with a carabiner gate that allows pet owners the ability to attach or “park” their pet to an object without needing to unlatch the pet from the leash.

### CROSS-REFERENCE TO RELATED APPLICATION

This application claims priority to U.S. Provisional Patent Application No. 63/188,901, filed on May 14, 2021 (pending), which is incorporated herein by reference in its entirety.

### TECHNICAL FIELD

The present disclosure generally relates to leash apparatuses, and more particularly to those having a carabiner handle.

### BACKGROUND

Although retractable pet leashes are popular, problems arise when a pet owner desires to “park” the dog to an object such as a bench or railing. Typically, the pet must be unlatched and held by the collar while the pet owner feeds the leash strap around the object and through the handle of the leash, attaching the leash to the object, then latching the leash back on to the pet.

Thus, improved techniques for securing pet leashes to various objects are generally desirable.

### SUMMARY

Disclosed herein is a novel device with an integrated means for attaching to a range of objects. The device will allow pet owners to attach a leash to an object without needing to unlatch the pet.

A general embodiment of the device comprises a reel, a housing assembly, a core, and a carabiner gate. Some embodiments of the housing comprise a first housing half and a second housing half, and includes a handle portion and a reel portion disposed around the reel. Some embodiments of the core are positioned between the first housing half and the second housing half, wherein a portion of the core surrounds the reel; in such embodiments the core may have a portion protruding from between the first body half and second body half. The carabiner gate may be rotatably coupled at a first end to the protruding portion of the core so that a second end of the carabiner gate is in contact with a carabiner gate slot when the carabiner gate is rotated to a first position, and wherein the second end is not in contact with the carabiner gate slot when the carabiner gate is rotated to a second position, wherein a lock may rotate to secure the second end within the gate slot in the first position, and wherein an object may be passed be-tween the gate slot and second end of the carabiner gate in the second position.

Another general embodiment of the device comprises a reel, a housing assembly, and a carabiner gate. In some embodiments the reel may be for spooling a leash. Some embodiments of the housing comprise a reel housing portion, a handle portion, and a core. In such embodiments, the reel housing portion may contain the reel and may be contiguous with the handle portion of the housing. The handle portion of the housing may be configured to be gripped in a user's hand and may be positioned such that there is an open space between the handle and the reel housing that can accommodate the user's fingers. In some embodiments, the core may form at least part of the handle portion and may be of a high-strength material. The core may also be connected to the reel to restrain the reel from being dislocated when pulled. Additionally, in some embodiments the carabiner gate may extend between the reel housing and the handle portion and be positioned so as to control access to the open space formed by handle portion and reel portion of housing.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a right-side view of a reel and handle for a leash in accordance with some embodiments of the present disclosure, the figure showing a gate closed and with leash gate lock in an unlocked position, with a stop button depressed and the lock button in a locked position.

FIG. 2 is an isometric view of the reel and handle for a leash of FIG. 1, but showing a reel unstopped and unlocked, with gate closed and locked.

FIG. 3 is a top view of a carabiner leash in accordance with some embodiments of the present disclosure, the figure showing a stop button depressed and the lock button in the locked position.

FIG. 4 is a right-side view of the reel and handle for a leash of FIG. 1, the figure showing a gate unlocked and open.

FIG. 5 is an isometric view of the reel and handle for a leash of FIG. 1, the figure showing a gate unlocked and closed.

FIG. 6 is an isometric view of the reel and handle for a leash of FIG. 1, the figure showing a gate locked and closed.

FIG. 7 is an isometric view of the reel and handle for a leash of FIG. 1, the figure showing a reel stopped and locked with gate closed and unlocked.

FIG. 8A is a front plan view of the reel and handle for a leash of FIG. 1, the figure showing the leash stopped with gate unlocked and closed.

FIG. 8B is a right-side section view of the reel and handle for a leash of FIG. 1, the figure showing the leash stopped with gate unlocked and closed.

FIG. 8C is a detail section view of a gate lock of the reel and handle for a leash of FIG. 1, the figure showing the gate unlocked and closed.

FIG. 9A is a front plan view of the reel and handle for a leash of FIG. 1, the figure showing the leash stopped with gate locked and closed.

FIG. 9B is a right-side section view of the reel and handle for a leash of FIG. 1, the figure showing the leash stopped with gate locked and closed.

FIG. 9C is a detail section view of a gate lock of the reel and handle for a leash of FIG. 1, the figure showing the gate locked and closed.

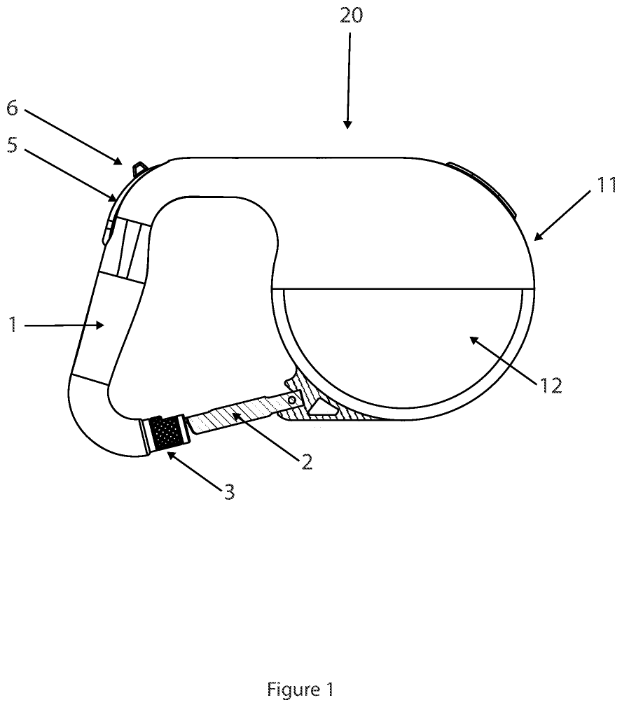

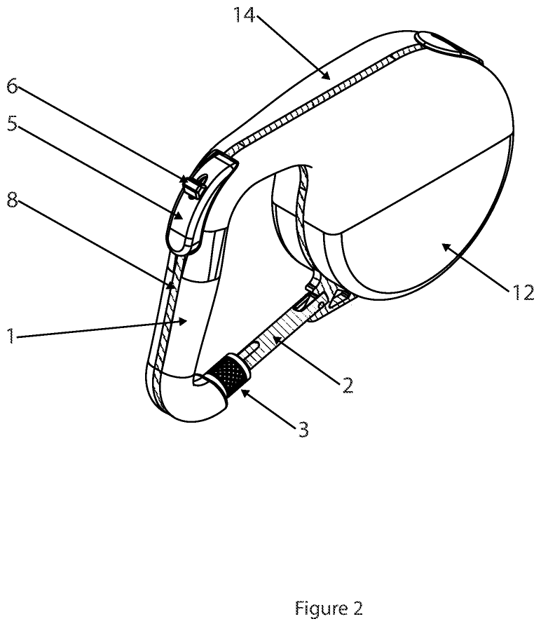

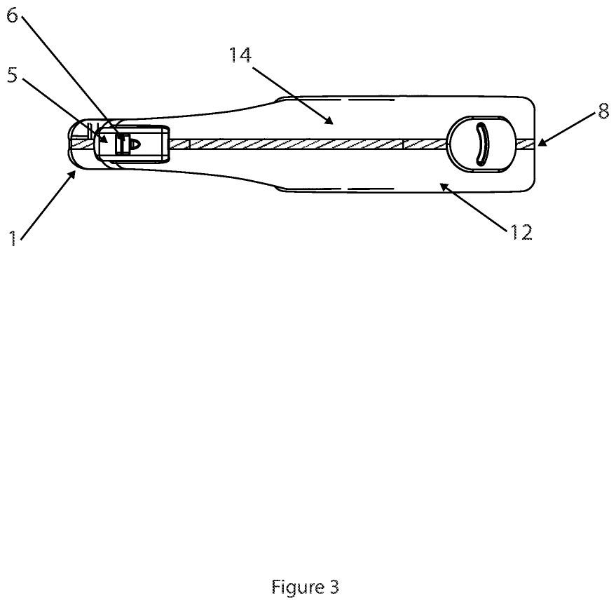

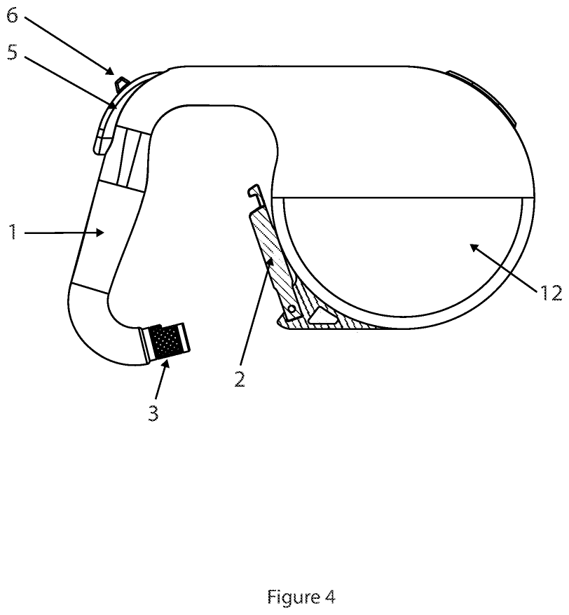

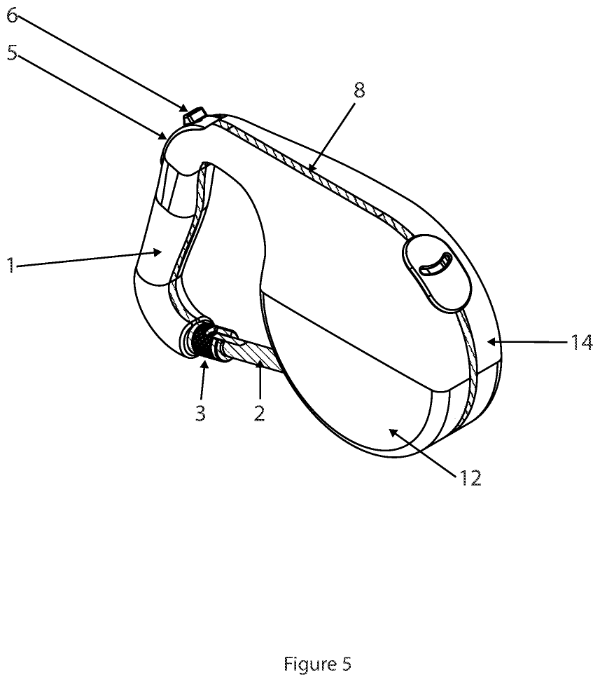

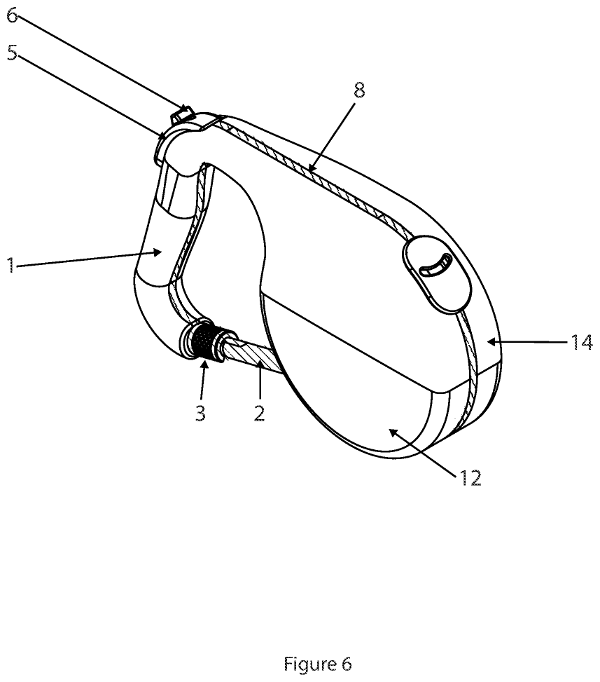

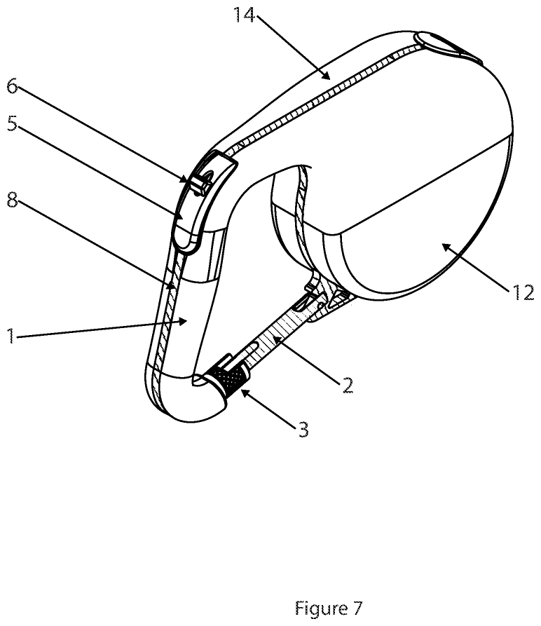

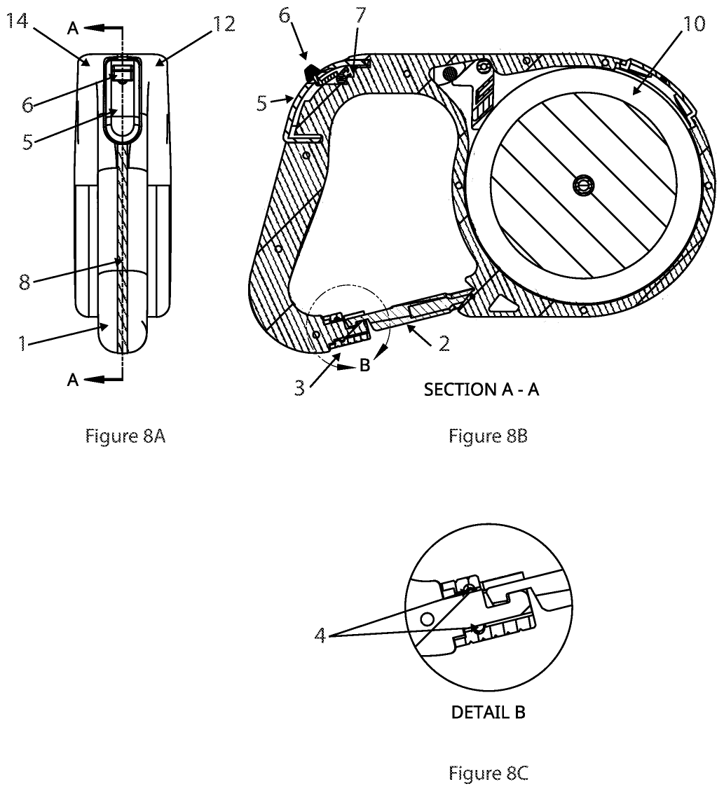

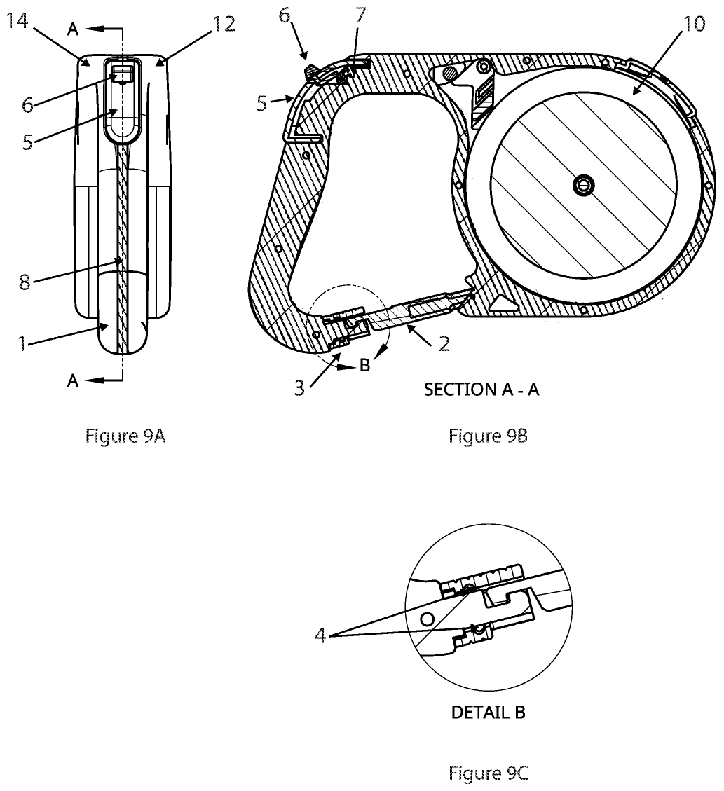

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The present disclosure generally relates to leash apparatuses, and more particularly to leashes having a carabiner handle.

A favorite hobby of many pet owners is going for walks with their pet. For example, many dog and cat owners will often take their pet for a walk every day or almost every day. Unfortunately, this can lead to undesirable encounters. For example, pets can attack other animals or people. In addition, pets can become distracted and run away or run into the street where they can be hit and killed. Because of these dangers, many states and cities now have ordinances requiring pets to be on a leash when outdoors.

A particularly popular type of leash among pet owners is a retractable leash. A retractable leash can allow the pet owner to vary the distance that the pet can be from the owner at any given time. In particular, the owner can allow the pet to wander farther away when it is safe to do so and keep the pet closer when it would be unsafe for the pet to wander.

In common usage, the term “leash” may refer to either the cord or strap (also called the lead or lead line) used by a user to restrain or guide an animal or may refer to the entirety of a leash apparatus, including the leash cord. While context usually makes the appropriate meaning apparent, to avoid confusion the term “leash assembly” is used herein when referring to the entirety of a leash apparatus while “leash cable” is used to refer to just the cable connecting the leash assembly to a leashed animal. Additionally, “leash body” is used herein when referring to the ridged portion of the leash apparatus, part of which is held in a user's hand and which is fixed to one end of the leash cord (with the other end of the leash cord being used to attach the leash apparatus to an animal).

In some embodiments, a leash assembly 20 may comprise a leash housing 11. In general, the leash housing 11 (also referred to simply as the housing 11) forms the outer surface of the leash assembly 20 and encloses other components of the leash assembly 20. In some embodiments the leash housing 11 comprises three components: a first housing half 12, a second housing half 14, and a central core 8. Broadly speaking, the first housing half 12 and second housing half 14 may each be thought of as comprising roughly half of the overall leash housing 11, with the central core 8 (also referred to simply as the core 8) being positioned along the seam where the first housing half 12 and the second housing half 14 (would otherwise) meet. In other words, the central core 8 is positioned between the first housing half 12 and the second housing half 14, such that the first housing half 12 and the second housing half 14 are positioned on lateral sides of the central core 8. This may effectively result in the core being sandwiched by the leash housing (i.e., the first housing half 12 and the second housing half 14). The central core 8 may be formed from a high-strength material, allowing it to provide additional strength for the leash housing 11.

In addition to its physical division into the first housing half 12, the second housing half 14, and the central core 8, the leash housing 11 may also be logically divided into a handle housing portion and a reel housing portion. At least part of the handle housing portion may be configured to be gripped in a user's hand, forming a handle 1. The handle 1 can allow a user to hold the leash assembly 20. That is, the handle 1 can allow a user to use the leash assembly to control an animal. On the other hand, the reel housing portion may define a space for (and essentially surround) a leash reel 10. The leash reel 10 (also referred to simply as the reel 10) may act as a reel around which a leash cable may be wound and unwound. In some embodiments, the leash reel 10 may be circular in shape in order to allow easy winding and unwinding. That is, the leash reel 10 may be rotated, which will wind or unwind the leash cable from the reel. The leash reel 10 may be mechanically fixed to both the leash housing 11 and to a leash cable.

The handle housing portion may be contiguous with the reel housing portion and may be positioned so at to allow an open space between the handle housing portion and the reel housing portion. This open space may be shaped so as to accommodate a user's fingers.

A portion of the central core 8 may surround the leash reel 10. The central core 8 may also be connected to the leash reel 10 to restrain the leash reel 10 from being dislocated when pulled. In some embodiments the central core 8 may comprise a portion protruding between the first housing half and the second housing half.

In some embodiments, the handle housing portion may be configured to act as a shackle. In particular, in some embodiments the handle housing portion may be configured to act as a carabiner (which is a particular type of shackle). In some embodiments, this is achieved by making part of the handle housing portion function as a carabiner gate, with that part of the handle housing portion referred to as the shackle gate 2 (or, when acting as a carabiner, as the carabiner gate 2). In general, the shackle gate 2 has a first end and a second end. The first end is (usually permanently) attached to the leash housing 11 such that it acts as a hinge, allowing the second end to be reversibly connected and disconnected (and moved towards or away from) the rest of the handle housing.

The area of leash housing 11 where the second end of the carabiner gate 2 couples with the rest of leash housing 11 may be referred to as a carabiner gate slot. The carabiner gate 2 may be hinged such that the second end of the carabiner gate 2 contacts the carabiner gate slot when the carabiner gate 2 is rotated to a first position and does not contact the carabiner gate slot when the carabiner gate 2 is rotated to a second position. In some embodiments, the first end of the shackle gate 2 is (rotatably) coupled to a protruding portion to the central core 8. In some embodiments, an object may be passed between the second end of the carabiner gate 2 and the carabiner gate slot when the carabiner gate 2 is in the second position.

In some embodiments, the shackle gate 2 may be secured by a gate lock 3. In particular, the area where the second end of the shackle gate 2 couples with the rest of leash housing 11 may be secured by the gate lock 3. The gate lock 3 may be positioned on the handle side, not on the carabiner gate, and locks by twisting. In other words, when the carabiner gate 2 is in the first position (and thus the second end of the carabiner gate 2 is in contact with the carabiner gate slot), the gate lock may rotate to secure the second end of the carabiner gate 2 within the gate slot (and thus hold the carabiner gate 2 in the first position).

Putting the gate lock 3 on the handle side may increase the usable space inside the area enclosed by the leash handle when the gate is open, allowing the leash to be attached to larger diameter objects (e.g., objects with greater cross-sectional area). The gate lock 3 may be similar to those used in climbing carabiners. For example, some embodiments of the gate lock 3 may include one or both of a spring-loading mechanism and screw-threads. However, in some embodiments, the gate lock 3 may not be spring-loaded and may not use screw threads. In some embodiments, the gate lock 3 may be guided by a gate lock rail 4 that is attached to the leash housing handle portion. In some embodiments, the gate lock rail 4 may comprise a left gate lock rail and a right gate lock rail.

In some embodiments, the leash assembly 20 may comprise a leash cable stop 5. In general, when being used to leash an animal, the leash cable will be extended for a certain length from the leash body, depending on the relative position of the leashed animal and the leash body. The leash cable stop 5 may be coupled to the leash reel 10 so as to fix the length of leash cable currently extended from the leash body (e.g., prevent from significantly increasing or decreasing in length) when the leash cable stop 5 is engaged. When the leash cable stop 5 is not engaged, the length of the leash cable currently extended from the leash body may change.

In some embodiments, the leash cable stop 5 may fix the leash cable to its currently extended length by preventing the leash reel 10 from rotating. In turn, preventing the leash reel 10 from rotating prevents the leash cable from winding or unwinding, meaning the leash cable maintains a constant length. In some embodiments, the leash cable stop 5 can be pushed by a user to cause a reel brake to contact the leash reel 10. As the reel brake comes in contact with the leash reel 10, the leash reel 10 is prevented from rotating. For example, the leash reel 10 can include one or more tabs. When the leash cable stop 5 is engaged, the reel brake is extended and rotation of the leash reel 10 causes the one or more tabs to come in contact with the reel brake, which prevents rotation of the leash reel 10.

In some embodiments, the leash cable stop 5 may comprise a stop switch (such as a button), which a user may engage by moving the switch to a first position. The stop switch may automatically disengage by returning to a second position unless actively held by a user. The stop switch may be configured to halt the rotation of the leash reel 10 when engaged, as described above. The stop switch may be positioned so as to be able to be engaged by a finger (such as a thumb) of a user when the user holds the handle 1.

In some embodiments, the leash cable stop 5 may comprise a stop button, which a user may engage be depressing. The stop button may fix the length of leash cable extended from the leash body while the stop button is depressed, as described above.

In some embodiments, the stop switch 5 is configured to be near the user's thumb when the user is holding the handle of the leash assembly 20. This can allow the user to maintain his or her grip on the handle 105 while simultaneously engaging the stop switch 5 to engage the manual brake. That is, the user can engage the stop switch 5 without loosening his or her grip on the handle of the leash assembly 20.

In some embodiments having the stop switch 5, the leash assembly 20 may further comprise a leash lock 6. In general, the leash lock 6 may be configured to keep the stop button 5 (and the associated reel brake) engaged until the leash lock 6 is disengaged by the user. That is, the leash lock 6 can allow the user to prevent rotation of the leash reel 10 without needing to continue to engage the stop switch 5.

In some embodiments, the leash lock 6 may comprise a leash lock button that engages when pressed by a user to maintain the engagement of a currently engaged stop button 5. In some of these embodiments, the leash lock button may keep a stop button 5 engaged by engaging with a lock button pin 7. By sliding past the lock button pin 7, the lock button 6 can be engaged to prevent the stop button 5 from returning to the unstopped position, which locks the leash reel 10.

In some embodiments, the leash lock 6 may comprise a lock switch configured to maintain the stop switch in an engaged position (i.e., the first position) when the lock switch is engaged. The lock switch may be positioned so as to be able to be engaged by a finger of a user when the user holds the handle 1.

In some embodiments, the lock button 6 may be attached to the stop button 5 through a pivot pin. In some embodiments, the lock button pin may be attached to the central core 8.

The central core 8 may comprise one or more metals. Example metals may include aluminum (CAS No. 7429-90-5), steel (CAS no. 7439-89-6), or otherwise.

In some embodiments, the leash housing 11 may be configured such that the handle housing portion may be positioned at a greater distance from the reel housing portion furthest from the user so the leash stop 5 and lock 6 buttons are notable. A path of movement may be tangent to the reel of the leash.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a”, “an” and “the” are intended to include the plural forms as well, unless the context clearly indicates otherwise.

Spatially relative terms, such as “under”, “below”, “lower”, “over”, “upper” and the like, may be used herein for ease of description to describe one element or feature's relationship to another when the apparatus is right side up.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

The term “adapted to” means designed or configured to accomplish the specified objective, not simply able to be made to accomplish the specified objective.

The term “consisting essentially of” means that, in addition to the recited elements, what is claimed may also contain other elements (steps, structures, ingredients, components, etc.) that do not adversely affect the operability of what is claimed for its intended purpose as stated in this disclosure. Importantly, this term excludes such other elements that adversely affect the operability of what is claimed for its intended purpose as stated in this disclosure, even if such other elements might enhance the operability of what is claimed for some other purpose.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description and accompanying drawings illustrate and describe certain processes, machines, manufactures, and compositions of matter, some of which embody the invention(s). Such descriptions or illustrations are not intended to limit the scope of what can be claimed, and are provided as aids in understanding the claims, enabling the making and use of what is claimed, and teaching the best mode of use of the invention(s). If this description and accompanying drawings are interpreted to disclose only a certain embodiment or embodiments, it shall not be construed to limit what can be claimed to that embodiment or embodiments. Any examples or embodiments of the invention described herein are not intended to indicate that what is claimed must be coextensive with such examples or embodiments. Where it is stated that the invention(s) or embodiments thereof achieve one or more objectives, it is not intended to limit what can be claimed to versions capable of achieving all such objectives. Any statements in this description criticizing the prior art are not intended to limit what is claimed to exclude any aspects of the prior art.

Additionally, the disclosure shows and describes certain embodiments of the processes, machines, manufactures, compositions of matter, and other teachings disclosed, but it is to be understood that the teachings of the present disclosure are capable of use in various other combinations, modifications, and environments and is capable of changes or modifications within the scope of the teachings as expressed herein.

Any section headings herein are provided only for consistency with the suggestions of 37 C.F.R. § 1.77 or otherwise to provide organizational queues. These headings shall not limit or characterize the invention(s) set forth herein.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

The following is claimed:

1. A leash assembly, comprising:
a reel;
a housing comprising a first housing half and a second housing half, the housing comprising a handle portion and a reel portion disposed around the reel;
a core positioned between the first housing half and the second housing half, wherein a portion of the core surrounds the reel, and wherein the core comprises a portion protruding from between the first housing half and second housing half; and
a carabiner gate rotatably coupled at a first end to the protruding portion of the core, wherein a second end of the carabiner gate is in contact with a carabiner gate slot when the carabiner gate is rotated to a first position, and wherein the second end is not in contact with the carabiner gate slot when the carabiner gate is rotated to a second position, wherein a gate lock may rotate to secure the second end within the gate slot in the first position, and wherein an object may be passed between the gate slot and second end of the carabiner gate in the second position.

2. The leash assembly of claim 1, further comprising:
a stop button coupled to the reel for fixing a length of leash cable extended from the leash body while the stop button is depressed; and
a leash lock coupled to the reel for fixing a length of leash cable extended from the leash body while the leash lock is in a first position.

3. The leash assembly of claim 2, wherein a length of leash cable extended from the housing may change while the stop button is not depressed, and wherein a length of leash cable extended from the leash body may change while the leash lock is in a second position.

4. A leash assembly, comprising:
a reel for spooling a leash;
a housing comprising:
a reel housing portion containing the reel;
a handle housing portion contiguous with the reel housing portion, the handle housing portion configured to be gripped in a user's hand, and positioned to allow an open space between the handle housing portion and the reel housing portion to accommodate a user's fingers; and
a core of high-strength material forming at least part of the handle housing portion and at least part of the reel housing portion; and
a carabiner gate extending between the reel housing portion and the handle housing portion and positioned to control access to the open space.

5. The leash assembly of claim 4, wherein the carabiner gate extends between parts of the core on the reel housing portion and the handle housing portion.

6. The leash assembly of claim 4, comprising a stop switch configured to halt rotation of the reel when engaged, wherein the stop switch is positioned to be engaged by a finger of the user when the user holds the handle housing portion.

7. The leash assembly of claim 6, comprising a lock switch configured to maintain the stop switch in an engaged position when the lock switch is engaged, wherein the lock switch is positioned to be engaged by a finger of the user when the user holds the handle housing portion.

8. The leash assembly of claim 4, comprising a housing portion sandwiching the core and forming the outer surface of the assembly.
